(19) United States
(12) Patent Application Publication
(10) Pub. No.: US 2008/0114839 A1
(43) Pub. Date: May 15, 2008

(54) Version Control for Application Message Models

(76) Inventor: Kenneth W. Borgendale, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/559,434

(22) Filed: Nov. 14, 2006

(51) Int. Cl. G06F 15/16

(52) U.S. Cl. 709/206

(57) ABSTRACT

Methods, systems, and products are disclosed for version control for application message models that include establishing, on a message sending device, a sender message model, the sender message model specifying a message format for interpreting application messages, the sender message model including one or more sender field specifications, each sender field specification specifying a message field for storing data in an application message, each sender field specification including sender field characteristics; calculating, by the message sending device, a sender version number for the sender message model in dependence upon the sender field characteristics of one or more of the sender field specifications of the sender message model; creating, by the message sending device, an application message according to the sender message model; and transmitting, by the message sending device to a message receiving device, the application message and the sender version number for the sender message model.

### BACKGROUND OF THE INVENTION

1. Field of the Invention

The field of the invention is data processing, or, more specifically, methods, systems, and products for version control for application message models.

2. Description of Related Art

Messaging environments are generally available to provide data communication between message sending devices and message receiving devices using application messages. An application message is a quantity of data organized into one or more data fields and is passed from a message producer installed on a message sending device to a message consumer installed on a message receiving device. An application message is a form of message recognized by application software operating in the application layer of a data communication protocol stack—as contrasted for example with a transport message or network message which are forms of messages recognized in the transport layer and the network layer respectively. An application message may represent, for example, numeric or textual information, images, encrypted information, and computer program instructions. In a financial market data environment, an application message is commonly referred to as a ‘tick’ and includes financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security.

Application messages are typically created and interpreted using a message model. The message model specifies the message format used to interpret the application messages. Although a messaging environment may only use one message model, often, messaging environments utilize many different message models to interpret a variety of application messages. To aid in identifying the correct model to use when interpreting an application message, the application message often contains a reference to the proper message model used to interpret the particular application message. Application messages that contain a reference to the model used to interpret the message are generally referred to as ‘self-describing’ application messages.

Even in message environments that only use one message model, several different versions of the message model may exist. Each version of the message model is typically assigned a version number by a software architect who designed the model. The version number of the message model used to create an application message is may be stored in the application message to identify which version of the message model should be used by a message consumer to interpret the message. To properly interpret an application message, both the message models and the version of the message models used to create and interpret the application message must match.

Often a software architect makes changes to a message model without changing the version number of the model. These changes may alter the interpretation of application messages created using the message model with respect to the previous version of the message model. When a software architect does not change the version number of the model, a message consumer typically does not detect that the version of the message model used to create the application message does not match the version of the message model used to interpret the message. Consequently, the message consumer will misinterpret the application message using an old version of the message model.

Although a software architect may often neglect to update the version number of a message model when the changes affect the interpretation of the messages created using the message model, the software architect may also change the version number for a message model when making changes that do not affect the interpretation of the messages created using the model. In such a situation, all the message consumers must obtain the new version of the message model before they can interpret any application messages even though the changes to the message model may not affect the interpretation of any application messages. As such, readers will therefore appreciate that room for improvement exists for controlling the versions of message models used for application message interpretation.

### SUMMARY OF THE INVENTION

Methods, systems, and products are disclosed for version control for application message models that include establishing, on a message sending device, a sender message model, the sender message model specifying a message format for interpreting application messages, the sender message model including one or more sender field specifications, each sender field specification specifying a message field for storing data in an application message, each sender field specification including sender field characteristics; calculating, by the message sending device, a sender version number for the sender message model in dependence upon the sender field characteristics of one or more of the sender field specifications of the sender message model; creating, by the message sending device, an application message according to the sender message model; and transmitting, by the message sending device to a message receiving device, the application message and the sender version number for the sender message model.

Version control for application message models may also include establishing, on a message receiving device, a receiver message model, the receiver message model specifying a message format for interpreting application messages, the receiver message model including one or more receiver field specifications, each receiver field specification specifying a message field for storing data in an application message, each receiver field specification including receiver field characteristics; calculating, by the message receiving device, a receiver version number for the receiver message model in dependence upon the receiver field characteristics of one or more of the receiver field specifications of the receiver message model; receiving, by the message receiving device from the message sending device, the application message and the sender version number for the sender message model; comparing, by the message receiving device, the receiver version number with the sender version number; and administering, by the message receiving device, the application message in dependence upon the comparison.

The sender field characteristics of at least one sender field specification may specify that a message field contains a constant value, and the receiver field characteristics of at least one receiver field specification may also specifies that the message field contains the constant value. In such an embodiment, creating, by the message sending device, an application message according to the sender message model may include creating the application message without the message field containing the constant value, and administering, by the message receiving device, the application message in dependence upon the comparison may include retrieving the constant value from the receiver message model if the receiver version number matches the sender version number.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network and block diagram illustrating an exemplary computer data processing system for version control for application message models according to exemplary embodiments of the present invention.

FIG. 2 sets forth a block diagram of automated computing machinery comprising an exemplary message sending device useful in version control for application message models according to exemplary embodiments of the present invention.

FIG. 3 sets forth a flowchart illustrating an exemplary method for version control for application message models according to exemplary embodiments of the present invention.

FIG. 4 sets forth a flowchart illustrating a further exemplary method for version control for application message models according to exemplary embodiments of the present invention.

FIG. 5 sets forth a flowchart illustrating a further exemplary method for version control for application message models according to exemplary embodiments of the present invention.

FIG. 6 sets forth a flowchart illustrating a further exemplary method for version control for application message models according to exemplary embodiments of the present invention.

### DETAILED DESCRIPTION OF EXEMPLARY EMBODIMENTS

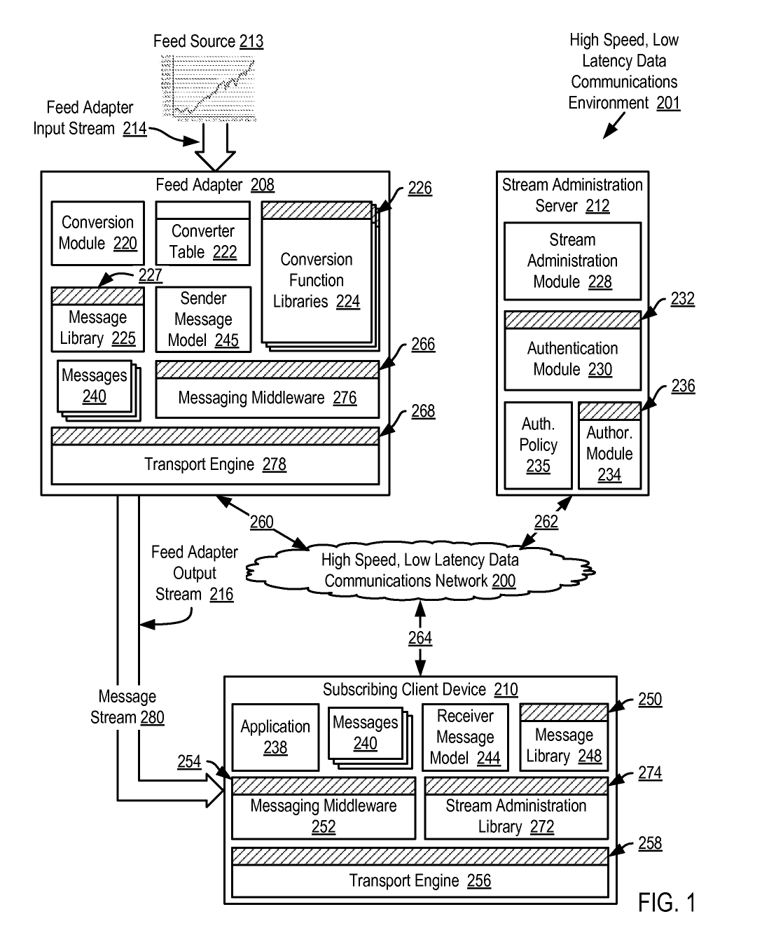

Exemplary methods, systems, and products for version control for application message models according to embodiments of the present invention are described with reference to the accompanying drawings, beginning with FIG. 1. FIG. 1 sets forth a network and block diagram illustrating an exemplary computer data processing system for version control for application message models according to embodiments of the present invention. The system of FIG. 1 operates generally for version control for application message models according to embodiments of the present invention as follows: A sender message model (245) is established on a message sending device (208). The sender message model (245) specifies a message format for interpreting application messages. The sender message model (245) includes one or more sender field specifications. Each sender field specification specifies a message field for storing data in an application message. Each sender field specification includes sender field characteristics. The message sending device (208) calculates a sender version number for the sender message model (245) in dependence upon the sender field characteristics of one or more of the sender field specifications of the sender message model (245). The message sending device (208) creates an application message according to the sender message model (245). The message sending device (208) transmits to a message receiving device (210) the application message and the sender version number for the sender message model (245). In the example of FIG. 1, the message sending device (208) is implemented as a feed adapter, and the message receiving device (210) is implemented as a subscribing client device.

The system of FIG. 1 may also operate generally for version control for application message models according to embodiments of the present invention as follows: A receiver message model (244) is established on a message receiving device (210). The receiver message model (244) specifies a message format for interpreting application messages and includes one or more receiver field specifications. Each receiver field specification specifies a message field for storing data in an application message and includes receiver field characteristics. The message receiving device (210) calculates a receiver version number for the receiver message model (244) in dependence upon the receiver field characteristics of one or more of the receiver field specifications of the receiver message model (244). The message receiving device (210) receives, from the message sending device (208), the application message and the sender version number for the sender message model (245). The message receiving device (210) compares the receiver version number with the sender version number and administers the application message in dependence upon the comparison.

The high speed, low latency data communications environment (201) illustrated in FIG. 1 includes a high speed, low latency data communications network (200). The network (200) includes a feed adapter (208), a stream administration server (212), and a subscribing client device (210), as well as the infrastructure for connecting such devices (208, 212, 210) together for data communications. The network (200) of FIG. 1 is termed ‘high speed, low latency’ because the application messages sent between devices connected to the network (200) on message streams administered by the stream administration server (212) bypass the stream administration server (212). For example, the application messages on the message stream (280) from the feed adapter (208) to the subscribing client device (210) bypass the stream administration server (212). Although such messages are not delayed for processing in the stream administration server (212), the stream administration server (212) retains administration of the stream (280) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (208, 212, 210) provides its own routing functionality for data communication through a direct connection with the other devices connected to the network (200). Because the network (200) does not include a computer networking device dedicated to routing data packets, the network (200) of FIG. 1 may be referred to as a ‘minimally routed network.’ Although the exemplary network (200) illustrated in FIG. 1 does not include a router, such a minimally routed network is for explanation only. In fact, some high speed, low latency networks useful in version control for application message models according to embodiments of the present invention may include a router.

The high speed, low latency data communications environment (201) depicted in FIG. 1 includes a message stream (280). A message stream is a data communication channel between a communications endpoint of a sending device and a communications endpoint of at least one receiving device. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 1 includes a stream administration server (212) connected to the high speed, low latency data communications network (200) through a wireline connection (262). The stream administration server (212) of FIG. 1 is a computer device having installed upon it a stream administration module (228), an authentication module (230), an authorization module (234), and an authorization policy (235). A stream administration module (228) is a software component that includes a set of computer program instructions configured for version control for application message models according to embodiments of the present invention. The stream administration module (228) operates generally for version control for application message models according to embodiments of the present invention by brokering establishment of a message stream (280) from the message sending device (208) to the message receiving device (210). In addition, the stream administration module (228) administers the message stream by providing security services such as authenticating the subscribing client device (210) and authorizing the subscribing client device (210) to receive application messages from the feed adapter (208) on the message stream (280).

The stream administration module (228) of FIG. 1 also operates generally for version control for application message models according to embodiments of the present invention by establishing, on a message sending device (208), a sender message model (245). The sender message model (245) specifies a message format for interpreting application messages on a message sending device and includes one or more sender field specifications. Each sender field specification specifies a message field for storing data in an application message and includes sender field characteristics. Examples of sender field characteristics may include a field identifier, a field size, and a field type. Similarly, the stream administration module (228) of FIG. 1 establishes a receiver message model (244) on a message receiving device (210).

The authentication module (230) of FIG. 1 is a set of computer program instructions capable of providing authentication security services to the stream administration module (228) through an exposed authentication application programming interface (‘API’) (232). Authentication is a process of verifying the identity of an entity. In the exemplary system of FIG. 1, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 1 is a set of computer program instructions capable of providing authorization security services to the stream administration module (228) through an exposed authorization API (236). Authorization is a process of only allowing resources to be used by resource consumers that have been granted authority to use the resources. In the example of FIG. 1, the authorization module (234) identifies the application messages that the subscribing client device (210) is authorized to receive on the message stream (280). The authorization module (234) of FIG. 1 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 1, feed adapter (208) is connected to the high speed, low latency data communications network (200) through a wireline connection (260). The feed adapter (208) is a computer device having the capabilities of converting application messages on a feed adapter input stream (214) having a first format to application messages on a feed adapter output stream (216) having a second format and transmitting the application messages on the feed adapter output stream (216) to subscribing client devices. The feed adapter input stream (214) is a message stream from a feed source to the feed adapter (208). The feed adapter output stream (216) is a message stream administered by the stream administration server (212) from the feed adapter (208) to the subscribing client device (210).

In the example of FIG. 1, the feed adapter (208) receives application messages on the feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data environment may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center_{SM} which is an electronic screen-based equity securities market in the United States. In a financial market data environment, a feed adapter input stream is referred to as a ‘financial market data feed.’

The feed adapter (208) of FIG. 1 has installed upon it a conversion module (220), a converter table (222), conversion function libraries (224), a message library (225), a sender message model (245), messaging middleware (276), and a transport engine (278). The conversion module (220) is a set of computer program instructions for converting application messages received on the feed adapter input stream (214) having a first format into application messages (240) having a second format for transmission to subscribing devices on the feed adapter output stream (216).

The conversion module (220) converts application messages from the first format to the second format according to the converter table (222). The converter table (222) of FIG. 1 is a data structure that specifies the converter functions capable of converting the application message from one format to another format. Utilizing multiple converter tables, the conversion module (220) may convert messages from a variety of input formats to a variety of output formats. In the example of FIG. 1, the converter table (222) specifies the converter functions capable of converting the application message received from the feed adapter input stream (214) having the first format to application messages (240) having the second format for transmission to subscribing client devices on the feed adapter output stream (216). The converter table (222) of FIG. 1 may be implemented using a structured document such as, for example, an eXtensible Markup Language (‘XML’) document.

The conversion function libraries (224) of FIG. 1 are loadable software modules that each contain one or more converter functions capable of converting data fields in an application message from one format to another format or converting values of data fields from one value to another value. The converter functions contained in the conversion function libraries may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions through a set of converter function APIs (226) exposed by the converter functions of the converter function libraries (224). In the example of FIG. 1, the conversion function libraries (224) may be implemented as dynamically linked libraries available to the conversion module (220) at runtime, statically linked libraries linked into the conversion module (220) at compile time, dynamically loaded Java classes, or any other implementation as will occur to those of skill in the art.

In the example of FIG. 1, the application messages (240) have a format specified in a sender message model (245). The sender message model (245) is metadata that defines the structure and the format used to create, access, and manipulate the application messages (240) converted from the application messages (not shown) received from the feed source (213). As mentioned above, the sender message model (245) specifies a message format for interpreting application messages and includes one or more sender field specifications. Each sender field specification specifies a message field for storing data in an application message and includes sender field characteristics. Typically the sender message model (245) is established on the feed adapter (208) by the stream administration server (212) when the stream administration server (212) brokers a message stream to a subscribing client device. A message model may be implemented using a structured document, such as, for example, an XML document, a Java object, C++ object, or any other implementation as will occur to those of skill in the art.

In the example of FIG. 1, the conversion module (220) and the converter functions of the conversion function libraries (224) process the data contained in the application messages (240) using the message library (225). The message library (225) is a software module that includes a set of functions for creating, accessing, and manipulating messages (240) according to a message model (245). The message library (225) also includes a set of computer program instructions for version control for application message model according to embodiments of the present invention.

The message library (225) operates generally for version control for application message model according to embodiments of the present invention by calculating a sender version number for the sender message model (245) in dependence upon the sender field characteristics of one or more of the sender field specifications of the sender message model (245), and creating an application message according to the sender message model (245). The message library (225) is accessible to the conversion module (220) and the converter functions of the conversion function libraries (224) through a message API (227) exposed by the message library (225).

Before the conversion module (220) of FIG. 1 performs data processing on the application messages, the conversion module (220) receives application messages (not shown) having a first format from the feed source (213). The conversion module (220) of FIG. 1 may receive the source stream messages through a receiving transport engine (not shown) of the feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

The messaging middleware (276) of FIG. 1 is a software component that provides high availability services between the feed adapter (208), any backup feed adapter that may exist, the subscribing client device (210), and the feed source (213). After the conversion module (220) of FIG. 1 performs data processing on the application messages received from the feed source (213), the messaging middleware (276) receives the application messages (240) having the second format and the sender version number for the sender message model (245) from the conversion module (220). The messaging middleware (276) then provides the received application messages and the sender version number to the transport engine (278) for transmission to a subscribing client device (210) on the feed adapter output stream (216). The conversion module (220) interacts with the messaging middleware (276) through a messaging middleware API (266) exposed by the messaging middleware (276).

The transport engine (278) of FIG. 1 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) is a software module that includes a set of computer program instructions for version control for application message models according to embodiments of the present invention. The transport engine (278) operates generally for version control for application message models according to embodiments of the present invention by transmitting application messages (240) and a sender version number for the sender message model (245) to a message receiving device (210). The messaging middleware (276) operates the transport engine (278) through a transport API (268) exposed by the transport engine (278). The transport engine (278) transmits the application messages (240) and the sender version number by encapsulating the application messages and the sender version number provided by the messaging middleware (276) into packets and transmitting the packets through the message stream (280) to the subscribing client device (210).

The subscribing client device (210) in exemplary system of FIG. 1 connects to the high speed, low latency data communications network (200) through a wireline connection (264). The subscribing client device (210) of FIG. 1 is a computer device capable of subscribing to the message streams transmitted by various feed adapters. In a financial market data environment, for example, a subscribing client device may subscribe to a tick to receive the bid and ask prices for a particular security on a message stream provided by a feed adapter controlled by a financial securities broker.

In the example of FIG. 1, the subscribing client device (210) has installed upon it an application (238), a message library (248), a receiver message model (244), messaging middleware (252), a stream administration library (272), and a transport engine (256). The application (238) is a software component that processes data contained in the application messages (240) received from the feed adapter (208). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

The application (238) processes the data contained in the application messages (240) using the message library (248). The message library (248) is software module that includes a set of functions for creating, accessing, and manipulating messages (240) according to a message model (244). The message library (248) includes a set of computer program instructions for version control for application message model according to embodiments of the present invention. The message library (248) operates generally for version control for application message model according to embodiments of the present invention by calculating a receiver version number for the receiver message model (244) in dependence upon the receiver field characteristics of one or more of the receiver field specifications of the receiver message model (244), comparing the receiver version number with the sender version number received from the message sending device, and administering the application message in dependence upon the comparison. The message library (248) is accessible to the application (238) through a message API (250) exposed by the message library (248).

In the example of FIG. 1, the message library (248) interprets the received application messages (240) using the receiver message model (244). The receiver message model (244) is metadata that specifies the structure and the format for interpreting the application messages (240) received on the message stream (280). The receiver message model (244) includes one or more receiver field specifications. Each receiver field specification specifies a message field for storing data in an application message and includes receiver field characteristics. Typically the receiver message model (244) is established on the subscribing client device (210) by the stream administration server (212) when the stream administration server (212) brokers a message stream to a subscribing client device. A message model may be implemented using a structured document, such as, for example, an XML document, a Java object, C++ object, or any other implementation as will occur to those of skill in the art.

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the application (238) of the subscribing client device (210) may request to subscribe to messages from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the messages (240), the application (238) receives the messages (240) and the sender version number for the sender message model (245) from the messaging middleware (252), which, in turn, receives the application messages (240) and the sender version number from the feed adapter (208) through the transport engine (256). The messaging middleware (252) is a software component that provides high availability services between the subscribing client device (210), the feed adapter (208), any backup feed adapters, and the stream administration module (212). In addition, the messaging middleware (252) provides message administration services for the stream administration server (212). Such message administration services may include restricting the ability of the application (238) to send and receive messages on a message stream to messages that satisfy certain constraints. The application (238) and the stream administration library (272) interact with the messaging middleware (252) through a messaging middleware API (254).

The transport engine (256) of FIG. 1 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) is a software component that includes a set of computer program instructions configured for version control for application message models according to embodiments of the present invention. The transport engine (256) operates generally for version control for application message models according to embodiments of the present invention by receiving, from the message sending device (208), application messages and a sender version number for the sender message model (245). The transport engine (256) receives the application messages and the sender version number by receiving packets through the message stream (280) from the feed adapter (208), unencapsulating the application messages and the sender version number from the received packets, and providing the application messages and the sender version number to the messaging middleware (252). The messaging middleware (252) operates the transport engine (256) through a transport API (258) exposed by the transport engine (256).

The servers and other devices illustrated in the exemplary system of FIG. 1 are for explanation, not for limitation. Devices useful in version control for application message models may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 1 are for explanation, not for limitation. Although the connections to the network (200) of FIG. 1 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 1.

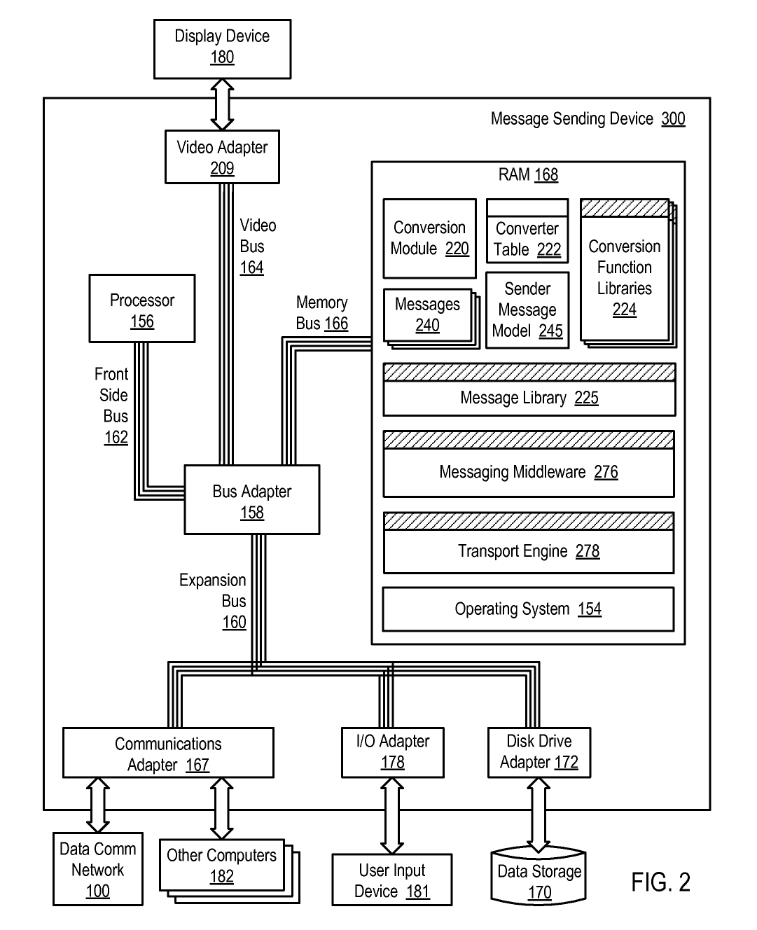

Version control for application message models in accordance with the present invention in some embodiments may be implemented with one or more message receiving devices, message sending devices, and stream administration servers. These devices and servers are, in turn, implemented to some extent at least as computers, that is, automated computing machinery. For further explanation, therefore, FIG. 2 sets forth a block diagram of automated computing machinery comprising an exemplary message sending device (300), such as, for example, an exemplary feed adapter, useful in version control for application message models according to embodiments of the present invention. The message sending device (300) of FIG. 2 includes at least one computer processor (156) or ‘CPU’ as well as random access memory (168) (‘RAM’) which is connected through a high speed memory bus (166) and bus adapter (158) to processor (156) and to other components of the message sending device.

Stored in RAM (168) are a conversion module (220), a converter table (222), conversion function libraries (224), application messages (240), sender message model (245), message library (225), messaging middleware (276), and transport engine (278). Each application message (240) is a quantity of data that includes one or more data fields and is transmitted from one device to another on a message stream. Application messages are typically created and processed by applications operating in application layers above the network and transport layers of a network protocol stack. As mentioned above, an application message may represent numeric or textual information, images, encrypted information, computer program instructions, and so on. In a financial market data environment, for example, a message is commonly referred to as a ‘tick’ and includes financial market data such as, for example, financial quotes or financial news. Each application message (240) may be implemented using a structured document such as, for example, an XML document, a Java object, C++ object, or any other implementation as will occur to those of skill in the art. The sender message model (245) is metadata that defines the structure and format for creating and interpreting the messages (240). The message model (245) may be implemented using a structured document such as, for example, an XML document, a Java object, C++ object, or any other implementation as will occur to those of skill in the art. The conversion module (220), the converter table (222), the conversion function libraries (224), the message library (225), the messaging middleware (276), and the transport engine (278) illustrated in FIG. 2 are software components, that is computer program instructions, that operate as described above with reference to FIG. 1 regarding the message sending device implemented as a feed adapter.

Also stored in RAM (168) is an operating system (154). Operating systems useful in message sending devices according to embodiments of the present invention include UNIX™, Linux™, Microsoft NT™, IBM's AIX™, IBM's i5/OS™, and others as will occur to those of skill in the art. The operating system (154), the conversion module (220), the converter table (222), the conversion function libraries (224), the messages (240), the sender message model (245), the message library (225), the messaging middleware (276), and the transport engine (278) in the example of FIG. 2 are shown in RAM (168), but many components of such software typically are stored in non-volatile memory also, for example, on a disk drive (170).

The exemplary message sending device (300) of FIG. 2 includes bus adapter (158), a computer hardware component that contains drive electronics for high speed buses, the front side bus (162), the video bus (164), and the memory bus (166), as well as drive electronics for the slower expansion bus (160). Examples of bus adapters useful in message sending devices useful according to embodiments of the present invention include the Intel Northbridge, the Intel Memory Controller Hub, the Intel Southbridge, and the Intel I/O Controller Hub. Examples of expansion buses useful in message sending devices useful according to embodiments of the present invention may include Peripheral Component Interconnect (‘PCI’) buses and PCI Express (‘PCIe’) buses.

The exemplary message sending device (300) of FIG. 2 also includes disk drive adapter (172) coupled through expansion bus (160) and bus adapter (158) to processor (156) and other components of the exemplary message sending device (300). Disk drive adapter (172) connects non-volatile data storage to the exemplary message sending device (300) in the form of disk drive (170). Disk drive adapters useful in message sending devices include Integrated Drive Electronics (‘IDE’) adapters, Small Computer System Interface (‘SCSI’) adapters, and others as will occur to those of skill in the art. In addition, non-volatile computer memory may be implemented for a message sending device as an optical disk drive, electrically erasable programmable read-only memory (so-called ‘EEPROM’ or ‘Flash’ memory), RAM drives, and so on, as will occur to those of skill in the art.

The exemplary message sending device (300) of FIG. 2 includes one or more input/output (‘I/O’) adapters (178). I/O adapters in message sending devices implement user-oriented input/output through, for example, software drivers and computer hardware for controlling output to display devices such as computer display screens, as well as user input from user input devices (181) such as keyboards and mice. The exemplary message sending device (300) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary message sending device (300) of FIG. 2 includes a communications adapter (167) for data communications with other computers (182) and for data communications with a high speed, low latency data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for version control for application message models according to embodiments of the present invention include modems for wired dial-up communications, IEEE 802.3 Ethernet adapters for wired data communications network communications, and IEEE 802.11b adapters for wireless data communications network communications.

Although FIG. 2 is discussed with reference to exemplary message sending devices, readers will note that automated computing machinery comprising exemplary message receiving devices, such as, for example, subscribing client devices, and exemplary stream administration servers useful in version control for application message models according to embodiments of the present invention are similar to the exemplary message sending device (300) of FIG. 2. That is, such exemplary stream administration servers and feed adapters include one or more processors, bus adapters, buses, RAM, video adapters, communications adapters, I/O adapters, disk drive adapters, and other components similar to the exemplary message sending device (300) of FIG. 2 as will occur to those of skill in the art.

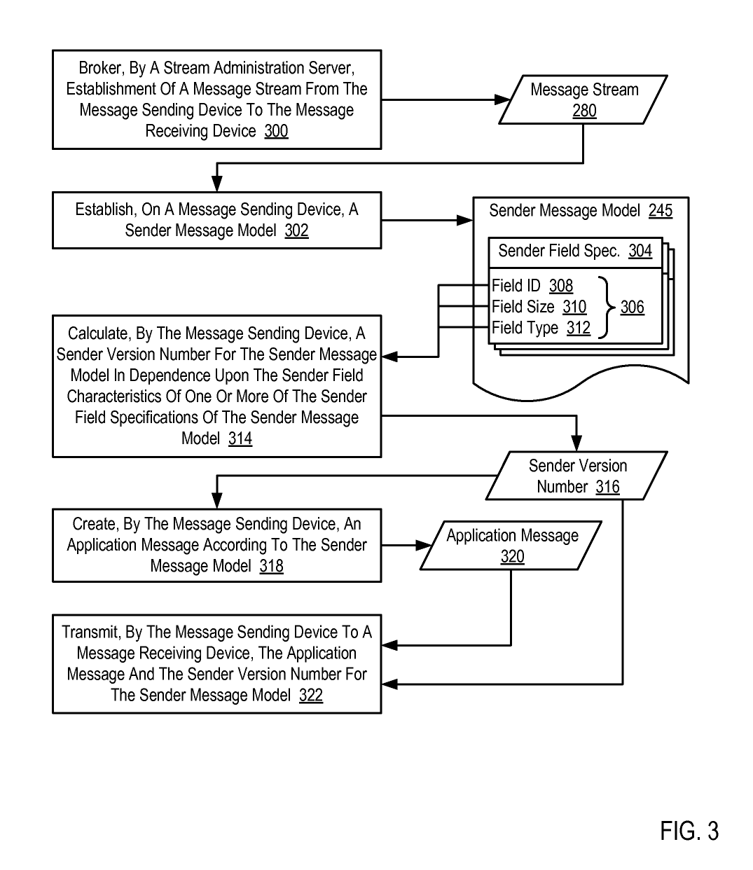

For further explanation, FIG. 3 sets forth a flowchart illustrating an exemplary method for version control for application message models according to embodiments of the present invention. The method of FIG. 3 includes brokering (300), by a stream administration server, establishment of a message stream (280) from the message sending device to the message receiving device. The message stream (280) represents a data communication channel between a communications endpoint of a message receiving device and a communications endpoint of a message sending device. A message stream may be implemented as a multicast data communication channel using the UDP/IP protocols or a unicast data communication channel using TCP/IP protocols as discussed above with reference to FIG. 1.

Brokering (300), by a stream administration server, establishment of a message stream (280) from the message sending device to the message receiving device according to the method of FIG. 3 may be carried out by receiving a subscription request from a message receiving device to subscribe to messages from a message sending device. The subscription request may be implemented as an XML document, a call to a member method of a RMI object on the message receiving device, or any other implementation as will occur to those of skill in the art. The subscription request may include topics of the messages that the message receiving device requests to receive from the message sending device. A topic represents the characteristics of the messages that the message receiving device requests. Using a topic, a message receiving device may specify the group of messages for receipt from the message sending device. In a financial market data environment, for example, a message receiving device may use a topic to request ticks from an OPRA feed source that contains quotes of an IBM option traded on the Chicago Board Options Exchange (‘CBOE’) that includes the best bid and best ask for the IBM option on the CBOE.

In the example of FIG. 3, brokering (300), by a stream administration server, establishment of a message stream (280) from the message sending device to the message receiving device may also include providing the message receiving device with a destination address for the message sending device. The destination address for the message sending device is a multicast address or a unicast address used by the message receiving device to listen for messages from a message sending device. Using the destination address provided by the stream administration server, the message receiving device may establish the message stream (280) from the message sending device to the message receiving device.

Before the stream administration server provides the destination address for the message sending device, the stream administration server in the example of FIG. 3 may perform several security services to ensure that the message receiving device only receives messages from the message sending device for which the message receiving device is authorized to receive. In the method of FIG. 3, brokering (300), by a stream administration server, establishment of a message stream (280) from the message sending device to the message receiving device may also be carried out by authenticating the message receiving device and authorizing the message receiving device to receive messages from the message sending device on the message stream (280). Authenticating the message receiving device may be carried out by verifying client security credentials provided by the message receiving device with the subscription request. The client security credentials may be implemented as a digital signature in a public key infrastructure, a security token, or any other security data as will occur to those of skill in the art for authenticating the identity of the originator of the subscription request. Authorizing the message receiving device to receive messages from the message sending device on the message stream (280) may be carried out by identifying the privileges associated with the authenticated message receiving device in dependence upon an authorization policy. An authorization policy is a set of rules governing the privileges of authenticated message receiving devices requesting to receive data from a message sending device.

The method of FIG. 3 also includes establishing (302), on a message sending device, a sender message model (245). The sender message model (245) is metadata that defines the structure and the format used to create, access, and manipulate application messages on the message sending device. That is, the sender message model (245) specifies a message format for interpreting application messages. The sender message model (245) of FIG. 3 includes one or more sender field specifications (304). Each sender field specification (304) is metadata that specifies a message field for an application message, typically, for storing data in the application message. Each sender field specification (304) of FIG. 3 includes sender field characteristics (306). Sender field characteristics (306) describe the attributes of the message field in an application message. In the example of FIG. 3, the sender field characteristics (306) of each sender field specification (304) include a field identifier (308), a field size (310), and field type (312). The field identifier (308) specifies a unique identifier for each field specified by the sender field specifications (304). The field size (310) specifies the size of each field specified by the sender field specifications (304). The field type (312) specifies the type of each field specified by the sender field specifications (304).

The method of FIG. 3 includes calculating (314), by the message sending device, a sender version number (316) for the sender message model (245) in dependence upon the sender field characteristics (306) of one or more of the sender field specifications (304) of the sender message model (245). A sender version number is a number that specifies a version of the sender message model (245). A message sending device may calculate (314) the sender version number according to the method of FIG. 3 by concatenating, into a string, the values specified by the sender field characteristics (306) of one or more of the sender field specifications (304) of the sender message model (245) and executing a hash function, such as, for example, cyclic redundancy check (‘CRC’), with the string to produce a checksum. The message sending device may use the value of the checksum as the value for the sender version number (316).

The method of FIG. 3 includes creating (318), by the message sending device, an application message (320) according to the sender message model (245). The message sending device may create (318) an application message (320) according to the sender message model (245) according to the method of FIG. 3 by generating a generic application message based on the message model that includes all of the default and constant values specified by the sender message model, storing the sender version number (316) in a field of the generic application message, and copying the application message (320) from the generic application message generated from the sender message model (245). Although from the description above readers will note that the sender version number (316) is stored in the application message (320), such a description is for explanation and not for limitation.

The method of FIG. 3 also includes transmitting (322), by the message sending device to a message receiving device, the application message (320) and the sender version number (316) for the sender message model (245). The message sending device may transmit (322), to a message receiving device, the application message (320) and the sender version number (316) for the sender message model (245) according to the method of FIG. 3 by encapsulating the application message (320) and the sender version number (316) into one or more transport packets and transmitting the transport packets through the message stream (280) to the message receiving device according to the UDP/IP protocols, TCP/IP protocols, or any other data communications protocols as will occur to those of skill in the art

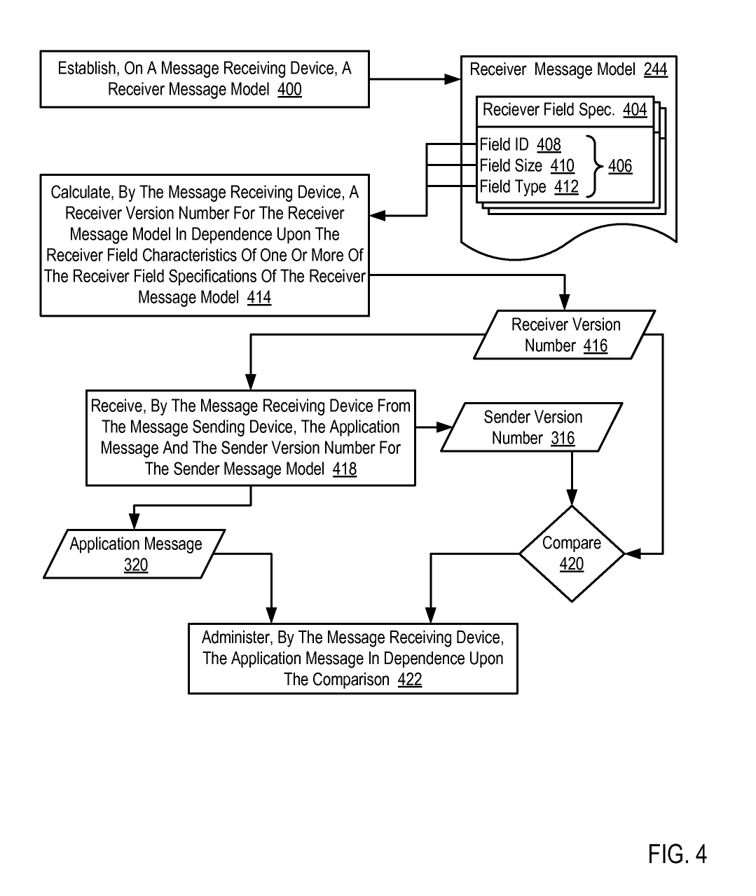

Similar to the sender message model established on the message sending device, a receiver message model is established on the message receiving device. The message receiving device compares the sender version number received from the message sending device to a receiver version number calculated by the message receiving device from a receiver message model. Based on such a comparison, the message receiving device administers the application message received from the message sending device. For further explanation, therefore, FIG. 4 sets forth a flowchart illustrating a further exemplary method for version control for application message models according to embodiments of the present invention.

The method of FIG. 4 includes establishing (400), on a message receiving device, a receiver message model (244). The receiver message model (244) is metadata that defines the structure and the format used to create, access, and manipulate application messages on the message receiving device. That is, the receiver message model (244) specifies a message format for interpreting application messages on the message receiving device. The receiver message model (244) of FIG. 4 includes one or more receiver field specifications (404). Each receiver field specification (404) is metadata that specifies a message field for an application message, typically, for storing data in the application message. Each receiver field specification (404) includes receiver field characteristics (406). Receiver field characteristics (406) describe the attributes of the message field in an application message. In the example of FIG. 4, the receiver field characteristics (406) of each sender field specification (404) include a field identifier (408), a field size (410), and field type (412). The field identifier (408) specifies a unique identifier for each field specified by the sender field specifications (404). The field size (410) specifies the size of each field specified by the sender field specifications (404). The field type (412) specifies the type of each field specified by the sender field specifications (404).

The method of FIG. 4 also includes calculating (414), by the message receiving device, a receiver version number (416) for the receiver message model (244) in dependence upon the receiver field characteristics (406) of one or more of the receiver field specifications (404) of the receiver message model (244). A receiver version number (416) is a number that specifies a version of the receiver message model (244). A message receiving device may calculate (414) the receiver version number according to the method of FIG. 4 by concatenating the values specified by the receiver field characteristics (406) of one or more of the receiver field specifications (404) of the receiver message model (245) into a string and executing a hash function, such as, for example, cyclic redundancy check (‘CRC’), with the string to produce a checksum. The message receiver device may use the value of the checksum as the value for the receiver version number (416).

The method of FIG. 4 includes receiving (418), by the message receiving device from the message sending device, the application message (320) and the sender version number (316) for the sender message model. The message receiving device may receive (418) the application message (320) and the sender version number (316) from the message sending device according to the method of FIG. 4 by receiving one or more transport packets from the message sending device that include the application message (320) and the sender version number (316) and unencapsulating the application message (320) and the sender version number (316) from the received transport packets. Because the application message itself may contain the sender version number (316), the message receiving device may also receive (418) the sender version number (316) from the message sending device according to the method of FIG. 4 by retrieving the sender version number (316) from the received application message using a messaging library.

The method of FIG. 4 also includes comparing (420), by the message receiving device, the receiver version number (416) with the sender version number (316). The message receiving device may compare (420) the receiver version number (416) with the sender version number (316) according to the method of FIG. 4 by determining whether the receiver version number (416) matches the sender version number (316). If the value for the receiver version number (416) equals the value for the sender version number (316), then the receiver version number (416) matches the sender version number (316), and the receiver message model matches the sender message model. If the value for the receiver version number (416) does not equal the value for the sender version number (316), then the receiver version number (416) does not match the sender version number (316), and the receiver message model does not match the sender message model.

Readers will note that a comparison between the receiver version number (416) and the sender version number (316) is affected by the particular field specifications and the field characteristics of each specification used to calculate the receiver version number (416) and the sender version number (316). By calculating the sender version number (316) and receiver version number (416) using every field specifications and every field characteristics of each specification from each message model, respectively, the sender version number (316) and receiver version number (416) typically will not match if any aspect of either the sender message model or the receiver message model has been altered. Omitting some of the field specifications or some of the field characteristics of each specification from the calculations of the sender version number (316) and receiver version number (416), however, allows for changes in the aspects of each model that were omitted from the calculations without affecting whether the sender version number (316) matches the receiver version number (416). In this manner, more than one sender version number and more than one receiver version number may be calculated to provide a multiple levels of version control for application message models according to the present invention.

For further explanation, consider, for example, that a sender version number and a receiver version number that are calculated using the field characteristics for both optional and required message fields. Any changes to the field characteristics for optional or required message fields in either a sender message model or a receiver message model would typically result in a sender version number that does not match the receiver version number. A comparison between such a receiver version number and a sender version number would indicate that the version of the receiver message model does not match the version of the sender message model. Similarly, consider another example in which a sender version number and a receiver version number are calculated using the field characteristics for only the required message fields. Any changes to the field characteristics for optional message fields in either a sender message model or a receiver message model would not typically result in a mismatch between the sender version number and the receiver version number. A comparison between such a receiver version number and a sender version number would indicate that the version of the receiver message model matches the version of the sender message model. These two examples above illustrate that more strict levels of version control may be implemented by including more field characteristics for more receiver field specifications in the calculation of the version numbers. Similarly, more lenient levels of version control may be implemented by including less field characteristics for less receiver field specifications in the calculation of the version numbers.

After comparing (420) the receiver version number (416) with the sender version number (316), the method of FIG. 4 also includes administering (422), by the message receiving device, the application message (320) in dependence upon the comparison. The message receiving device may administer (422) the application message (320) in dependence upon the comparison according to the method of FIG. 4 by denying a application software access to the application message (320) if the receiver version number (416) does not match the sender version number (316). The message receiving device may also administer (422) the application message (320) in dependence upon the comparison according to the method of FIG. 4 by allowing application software access to the application message (320) if the receiver version number (416) matches the sender version number (316).

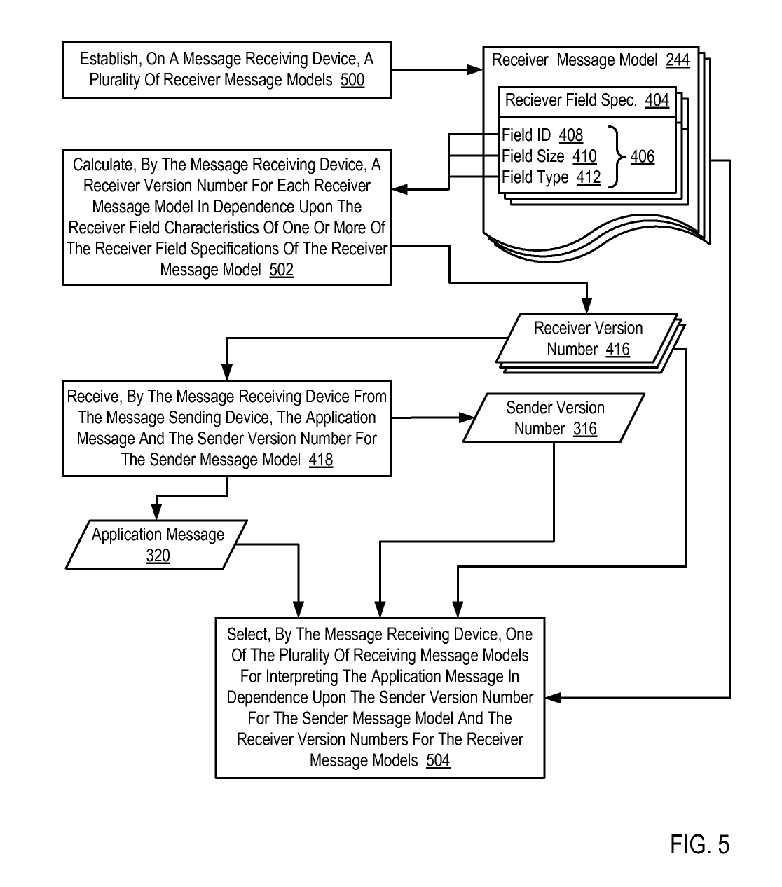

In the description of FIG. 4 above, the message receiving device is described as having one version of a receiver message model installed upon the message receiving device. Readers will note that such a description is for explanation and not for limitation. In fact, more than one version of a receiver message model is often included on the message receiving device because older versions of the message model are typically not removed from the message receiving device when new versions of the message model are established on the device. Using the receiver version numbers for each of the receiver message models on the message receiving device and the sender version number for the received application message, a message receiving device may select one of the receiving message models for interpreting the application message. For further explanation, therefore, FIG. 5 sets forth a flowchart illustrating a further exemplary method for version control for application message models according to embodiments of the present invention that includes selecting (504), by the message receiving device, one of the plurality of receiving message models (244) for interpreting the application message (320) in dependence upon the sender version number (316) for the sender message model and the receiver version numbers (416) for the receiver message models (244).

The method of FIG. 5 includes establishing (500), on a message receiving device, a plurality of receiver message models (244). Each receiver message model (244) in the example of FIG. 5 is similar to the receiver message model described above with reference to FIG. 4. That is, each receiver message model (244) specifies a message format for interpreting application messages and includes one or more receiver field specifications (404). Each receiver field specification (404) specifies a message field for storing data in an application message and includes receiver field characteristics (406). In the example of FIG. 5, receiver field characteristics (406) include a field identifier (408), a field size (410), and a field type (412). In the method of FIG. 5, establishing (500), on a message receiving device, a plurality of receiver message models (244) may be carried out as described above with reference to FIG. 4.

The method of FIG. 5 also includes calculating (502), by the message receiving device, a receiver version number (416) for each receiver message model (244) in dependence upon the receiver field characteristics of one or more of the receiver field specifications of the receiver message model. A receiver version number (416) is a number that specifies a version of one of the receiver message models (244). Calculating (502), by the message receiving device, a receiver version number (416) for each receiver message model (244) according to the method of FIG. 5 may be carried out as described above with reference to FIG. 4.

The method of FIG. 5 includes receiving (418), by the message receiving device from the message sending device, the application message (320) and the sender version number (316) for the sender message model. The message receiving device may receive (418) the application message (320) and the sender version number (316) from the message sending device according to the method of FIG. 5 by receiving one or more transport packets from the message sending device that include the application message (320) and the sender version number (316) and unencapsulating the application message (320) and the sender version number (316) from the received transport packets. Because the application message itself may contain the sender version number (316), the message receiving device may receive (418) the application message (320) and the sender version number (316) from the message sending device according to the method of FIG. 5 by retrieving the sender version number (316) from the application message using a messaging library.

The method of FIG. 5 also includes selecting (504), by the message receiving device, one of the plurality of receiving message models (244) for interpreting the application message (320) in dependence upon the sender version number (316) for the sender message model and the receiver version numbers (416) for the receiver message models (244). The message receiving device may select (504) one of the plurality of receiving message models (244) for interpreting the application message (320) according to the method of FIG. 5 by comparing the receiver version number (416) for each receiver message model (244) with the sender version number (316) and selecting the receiver message model (244) having the receiver version number (416) that matches the sender version number (316). The message receiving device may utilize the selected receiver message model to interpret the application message (320).

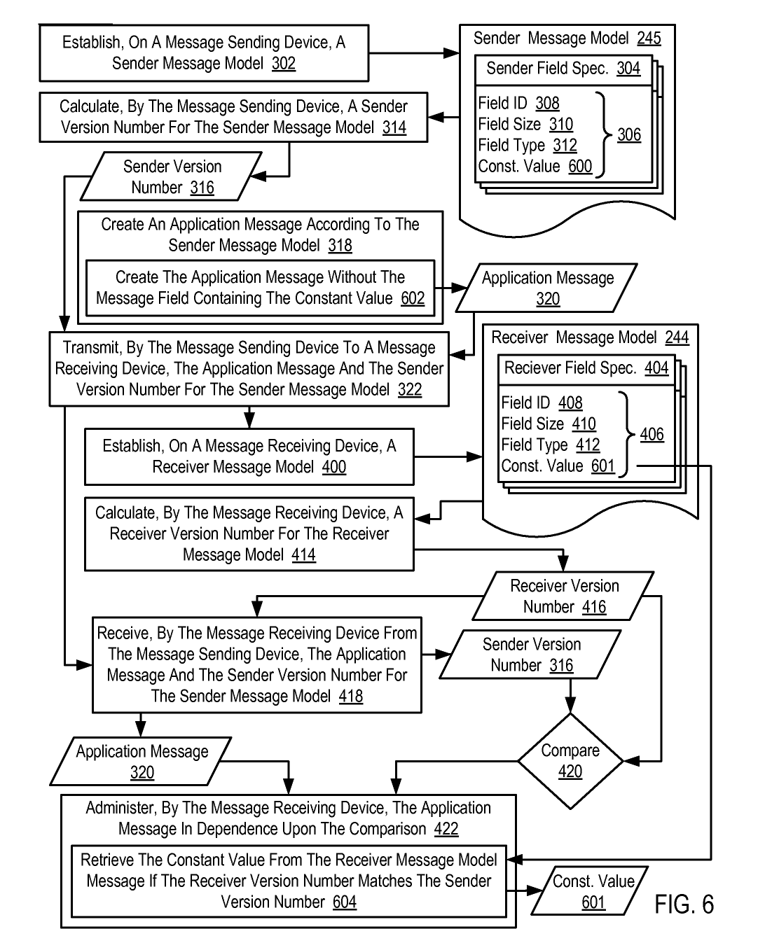

As described above, an application message transmitted from a message sending device to a message receiving device typically does not include the metadata describing the message format used to interpret the application message. Instead, such metadata is stored in message models that are established on the message sending device and the message receiving device. Storing this metadata in the message models instead of the application messages themselves advantageously reduces the size of the application messages and reduces the transmission of redundant data across the network. Reducing the size of the application messages and the transmission of redundant data increases the number of application message that may be transmitted using a fixed quantity of network resources. The size of application messages and the transmission of redundant data may be further reduced by storing constant values and default values for the fields of application messages in the message models instead of storing those values in the application messages themselves. For further explanation, therefore, FIG. 6 sets forth a flowchart illustrating a further exemplary method for version control for application message models according to embodiments of the present invention that includes retrieving (604) a constant value (600) from the receiver message model (244).

The method of FIG. 6 is similar to the methods of FIGS. 3 and 4. That is, the method of FIG. 6 includes establishing (302), on a message sending device, a sender message model (245), calculating (314), by the message sending device, a sender version number (316) for the sender message model (245) in dependence upon the sender field characteristics (306) of one or more of the sender field specifications of the sender message model (245), creating (318), by the message sending device, an application message (320) according to the sender message model (245), and transmitting (322), by the message sending device to a message receiving device, the application message (320) and the sender version number (316) for the sender message model (245). The method of FIG. 6 also includes establishing (400), on a message receiving device, a receiver message model (244), calculating (414), by the message receiving device, a receiver version number (416) for the receiver message model (244) in dependence upon the receiver field characteristics (406) of one or more of the receiver field specifications (404) of the receiver message model (244), receiving (418), by the message receiving device from the message sending device, the application message (320) and the sender version number (316) for the sender message model, comparing (420), by the message receiving device, the receiver version number with the sender version number, and administering (422), by the message receiving device, the application message (320) in dependence upon the comparison.

In the example of FIG. 6, the sender message model (245) is also similar to the examples of FIGS. 3 and 4. The sender message model (245) of FIG. 6 specifies a message format for interpreting application messages and includes one or more sender field specifications (304). Each sender field specification (304) of FIG. 6 specifies a message field, typically, for storing data in an application message and includes sender field characteristics (306). In the example of FIG. 6, the sender field characteristics (306) include a field identifier (308), a field size (310), and a field type (312). The example of FIG. 6 differs from the example of FIGS. 3 and 4, however, in that the sender field characteristics (306) of at least one sender field specification (304) specify that a message field contains a constant value (600).

In the method of FIG. 6, creating (318), by the message sending device, an application message (320) according to the sender message model (245) includes creating (602) the application message without the message field containing the constant value (600). The constant value (600) of FIG. 6 represents a constant value for a message field that is not actually contained in the application messages created from the sender message model (245). Because a message field with a constant value is the same for all messages created from the sender message model (245), the constant value (600) for the application messages is stored in the sender message model (244) to reduce the size of the application messages.

In the example of FIG. 6, the receiver message model (244) is also similar to the examples of FIGS. 3 and 4. That is, the receiver message model (244) specifies a message format for interpreting application messages and includes one or more receiver field specifications (404). Each receiver field specification (404) specifies a message field, typically, for storing data in an application message and includes receiver field characteristics (406). In the example of FIG. 6, the receiver field characteristics (406) include a field identifier (408), a field size (410), and a field type (412). Similar to the sender message model (245) of FIG. 6, however, the example of FIG. 6 differs from the example of FIGS. 3 and 4 in that the sender field characteristics (406) of at least one receiver field specification (404) specify that a message field contains a constant value (601).

In the method of FIG. 6, administering (422), by the message receiving device, the application message (320) in dependence upon the comparison includes retrieving (604) the constant value (601) from the receiver message model (244) if the receiver version number (416) matches the sender version number (316). The constant value (601) of FIG. 6 represents a constant value for a message field that is not actually contained in the application messages interpreted using the receiver message model (244). Rather, the constant value (601) is stored in the receiver message model (244) along with the receiver field specification describing the constant message field. As mentioned above, when the receiver version number (416) matches the sender version number (316), the receiver message model (244) matches the sender message model (245). When the receiver message model (244) matches the sender message model (245), the constant value (601) matches the constant value (600) for corresponding message field specifications. Retrieving (604) the constant value (601) from the receiver message model (244), therefore, returns the same value as retrieving the constant value (600) from the sender message model (245) used to create the application message (320), and effectively bypasses the need to include the constant data in the application message (320).

In the method of FIG. 6, the message receiving device may retrieve (604) the constant value (601) from the receiver message model (244) using a message library as discussed above. When a messaging function of the message library receives a request from application software to retrieve a value from a message field of an application message, the application software typically provides the value of the field identifier (408) for the message field to the messaging function. The messaging function may use the field identifier (408) to determine the offset location of the message field containing the constant value (601) from the beginning of the application message. Offset locations for each field may be determined using the values for the field size (410) specified for each message field in the receiver message model (244).

In the example of FIG. 6, the message models (244, 245) designate higher values for the field order of the message fields containing constant values than all of the other message fields. Designating higher values for the field order of the message fields containing constant values than all of the other message fields results in the message fields containing constant values having greater offset locations from the beginning of the application message than all of the other message fields. When the messaging function determines the offset location of the message field containing the constant value (601) using the receiver message model (244), the message function therefore can identify the message field as a message field containing a constant value if the offset location for the field is greater than the size of the application message. If the offset location for the field specified by the application software is greater than the size of the application message provided by the application software, then the messaging function retrieves the constant value (601) from the receiver message model (244) and returns the constant value (601) to the application software using the message library. If the offset location for the field specified by the application software is less than the size of the application message provided by the application software, however, then the messaging function determines that the field specified by the application software is not a message field containing a constant value, and the messaging function retrieves the value for the field from the application message and returns the retrieved value to the application software using the message library.

In view of the explanations set forth above in this document, readers will recognize that version control for application message models according to embodiments of the present invention provides the following benefits:
the ability to assign a version number to a message model for interpreting application messages based on the application message format specified by the message model,
the ability to assign multiple version numbers to a message model depending on the level of compatibility between message models desired in a messaging environment, and
the ability to reduce the size of application messages and the transmission of redundant data in a messaging environment by storing constant values for an application message in the message model rather than the application message itself.

Exemplary embodiments of the present invention are described largely in the context of a fully functional computer system for version control for application message models. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of version control for application message models, the method comprising:
establishing, on a message sending device, a sender message model, the sender message model specifying a message format for interpreting application messages, the sender message model comprising one or more sender field specifications, each sender field specification specifying a message field for storing data in an application message, each sender field specification comprising sender field characteristics;
calculating, by the message sending device, a sender version number for the sender message model in dependence upon the sender field characteristics of one or more of the sender field specifications of the sender message model;
creating, by the message sending device, an application message according to the sender message model; and
transmitting, by the message sending device to a message receiving device, the application message and the sender version number for the sender message model.

2. The method of claim 1 wherein sender field characteristics further comprise a field identifier, a field size, and a field type.

3. The method of claim 1 further comprising:
establishing, on a message receiving device, a receiver message model, the receiver message model specifying a message format for interpreting application messages, the receiver message model comprising one or more receiver field specifications, each receiver field specification specifying a message field for storing data in an application message, each receiver field specification comprising receiver field characteristics;
calculating, by the message receiving device, a receiver version number for the receiver message model in dependence upon the receiver field characteristics of one or more of the receiver field specifications of the receiver message model;
receiving, by the message receiving device from the message sending device, the application message and the sender version number for the sender message model;
comparing, by the message receiving device, the receiver version number with the sender version number; and
administering, by the message receiving device, the application message in dependence upon the comparison.

4. The method of claim 3 wherein:
the sender field characteristics of at least one sender field specification specify that a message field contains a constant value;
the receiver field characteristics of at least one receiver field specification also specifies that the message field contains the constant value;
creating, by the message sending device, an application message according to the sender message model further comprises creating the application message without the message field containing the constant value; and
administering, by the message receiving device, the application message in dependence upon the comparison further comprises retrieving the constant value from the receiver message model if the receiver version number matches the sender version number.

5. The method of claim 1 further comprising
establishing, on a message receiving device, a plurality of receiver message models, each receiver message model specifying a message format for interpreting application messages, each receiver message model comprising one or more receiver field specifications, each receiver field specification specifying a message field for storing data in an application message, each receiver field specification comprising receiver field characteristics;
calculating, by the message receiving device, a receiver version number for each receiver message model in dependence upon the receiver field characteristics of one or more of the receiver field specifications of the receiver message model;
receiving, by the message receiving device from the message sending device, the application message and the sender version number for the sender message model; and
selecting, by the message receiving device, one of the plurality of receiving message models for interpreting the application message in dependence upon the sender version number for the sender message model and the receiver version numbers for the receiver message models.

6. The method of claim 1 further comprising brokering, by a stream administration server, establishment of a message stream from the message sending device to the message receiving device.

7. The method of claim 1 wherein:
the message receiving device is a subscribing client device; and
the message sending device is a feed adapter having the capabilities of converting application messages on a feed adapter input stream having a first format to application messages on a feed adapter output stream having a second format and transmitting the application messages on the feed adapter output stream to subscribing client devices.

8. The method of claim 1 wherein the application message further comprises financial market data.

9. A system for version control for application message models, the system comprising one or more computer processors, computer memory operatively coupled to the one or more computer processors, the computer memory having disposed within it computer program instructions capable of:
establishing, on a message sending device, a sender message model, the sender message model specifying a message format for interpreting application messages, the sender message model comprising one or more sender field specifications, each sender field specification specifying a message field for storing data in an application message, each sender field specification comprising sender field characteristics;
calculating, by the message sending device, a sender version number for the sender message model in dependence upon the sender field characteristics of one or more of the sender field specifications of the sender message model;
creating, by the message sending device, an application message according to the sender message model; and
transmitting, by the message sending device to a message receiving device, the application message and the sender version number for the sender message model.

10. The system of claim 9 further comprising computer program instructions capable of:
establishing, on a message receiving device, a receiver message model, the receiver message model specifying a message format for interpreting application messages, the receiver message model comprising one or more receiver field specifications, each receiver field specification specifying a message field for storing data in an application message, each receiver field specification comprising receiver field characteristics;
calculating, by the message receiving device, a receiver version number for the receiver message model in dependence upon the receiver field characteristics of one or more of the receiver field specifications of the receiver message model;
receiving, by the message receiving device from the message sending device, the application message and the sender version number for the sender message model;
comparing, by the message receiving device, the receiver version number with the sender version number; and
administering, by the message receiving device, the application message in dependence upon the comparison.

11. The system of claim 10 wherein:
the sender field characteristics of at least one sender field specification specify that a message field contains a constant value;
the receiver field characteristics of at least one receiver field specification also specifies that the message field contains the constant value;
creating, by the message sending device, an application message according to the sender message model further comprises creating the application message without the message field containing the constant value; and
administering, by the message receiving device, the application message in dependence upon the comparison further comprises retrieving the constant value from the receiver message model if the receiver version number matches the sender version number.

12. The system of claim 9 further comprising computer program instructions capable of:
establishing, on a message receiving device, a plurality of receiver message models, each receiver message model specifying a message format for interpreting application messages, each receiver message model comprising one or more receiver field specifications, each receiver field specification specifying a message field for storing data in an application message, each receiver field specification comprising receiver field characteristics;
calculating, by the message receiving device, a receiver version number for each receiver message model in dependence upon the receiver field characteristics of one or more of the receiver field specifications of the receiver message model;
receiving, by the message receiving device from the message sending device, the application message and the sender version number for the sender message model; and
selecting, by the message receiving device, one of the plurality of receiving message models for interpreting the application message in dependence upon the sender version number for the sender message model and the receiver version numbers for the receiver message models.

13. A computer program product for version control for application message models, the computer program product disposed upon a signal bearing medium, the computer program product comprising computer program instructions capable of:
establishing, on a message sending device, a sender message model, the sender message model specifying a message format for interpreting application messages, the sender message model comprising one or more sender field specifications, each sender field specification specifying a message field for storing data in an application message, each sender field specification comprising sender field characteristics;
calculating, by the message sending device, a sender version number for the sender message model in dependence upon the sender field characteristics of one or more of the sender field specifications of the sender message model;
creating, by the message sending device, an application message according to the sender message model; and
transmitting, by the message sending device to a message receiving device, the application message and the sender version number for the sender message model.

14. The computer program product of claim 13 wherein the signal bearing medium comprises a recordable medium.

15. The computer program product of claim 13 wherein the signal bearing medium comprises a transmission medium.

16. The computer program product of claim 13 further comprising computer program instructions capable of:
establishing, on a message receiving device, a receiver message model, the receiver message model specifying a message format for interpreting application messages, the receiver message model comprising one or more receiver field specifications, each receiver field specification specifying a message field for storing data in an application message, each receiver field specification comprising receiver field characteristics;
calculating, by the message receiving device, a receiver version number for the receiver message model in dependence upon the receiver field characteristics of one or more of the receiver field specifications of the receiver message model;
receiving, by the message receiving device from the message sending device, the application message and the sender version number for the sender message model;
comparing, by the message receiving device, the receiver version number with the sender version number; and
administering, by the message receiving device, the application message in dependence upon the comparison.

17. The computer program product of claim 16 wherein:
the sender field characteristics of at least one sender field specification specify that a message field contains a constant value;
the receiver field characteristics of at least one receiver field specification also specifies that the message field contains the constant value;
creating, by the message sending device, an application message according to the sender message model further comprises creating the application message without the message field containing the constant value; and
administering, by the message receiving device, the application message in dependence upon the comparison further comprises retrieving the constant value from the receiver message model if the receiver version number matches the sender version number.

18. The computer program product of claim 13 further comprising computer program instructions capable of:
establishing, on a message receiving device, a plurality of receiver message models, each receiver message model specifying a message format for interpreting application messages, each receiver message model comprising one or more receiver field specifications, each receiver field specification specifying a message field for storing data in an application message, each receiver field specification comprising receiver field characteristics;
calculating, by the message receiving device, a receiver version number for each receiver message model in dependence upon the receiver field characteristics of one or more of the receiver field specifications of the receiver message model;
receiving, by the message receiving device from the message sending device, the application message and the sender version number for the sender message model; and
selecting, by the message receiving device, one of the plurality of receiving message models for interpreting the application message in dependence upon the sender version number for the sender message model and the receiver version numbers for the receiver message models.

19. The computer program product of claim 13 further comprising computer program instructions capable of brokering, by a stream administration server, establishment of a message stream from the message sending device to the message receiving device.

20. The computer program product of claim 13 wherein:
the message receiving device is a subscribing client device; and
the message sending device is a feed adapter having the capabilities of converting application messages on a feed adapter input stream having a first format to application messages on a feed adapter output stream having a second format and transmitting the application messages on the feed adapter output stream to subscribing client devices.
